(19) United States
(12) Patent Application Publication
(10) Pub. No.: US 2024/0152877 A1
(43) Pub. Date: May 9, 2024

(54) INFRASTRUCTURE MAINTENANCE MANAGEMENT SUPPORT SYSTEM

(71) Applicant: Nomura Research Institute, Ltd., Tokyo (JP)

(72) Inventors: Seiichirou Yano, Tokyo (JP); Tomohiko Noguchi, Tokyo (JP); Yukio Ookouchi, Tokyo (JP)

(21) Appl. No.: 18/385,935

(22) Filed: Nov. 1, 2023

(30) Foreign Application Priority Data
Nov. 4, 2022 (JP) 2022-177520

(51) Int. Cl. G06Q 10/20; G06Q 10/04; G06Q 50/26

(52) U.S. Cl. CPC G06Q 10/20; G06Q 10/04; G06Q 50/26

(57) ABSTRACT

Included is a data management unit that acquires and holds data including map data, sensing data, and repair actual result data, a map display unit that displays information regarding a state of an infrastructure determined on the basis of the sensing data in a superimposed manner on a map image, a repair support unit that predicts a future degree of deterioration of each infrastructure on the basis of data including the sensing data and presents a candidate for an infrastructure to be repaired on the basis of information including the prediction, and an operation/management unit that displays a result of aggregation of the sensing data and maintenance management related data on a dashboard.

### BACKGROUND OF THE INVENTION

### 1. Technical Field

The present invention relates to a technology of infrastructure maintenance management, and especially relates to a technology that is effective when applied to an infrastructure maintenance management support system for infrastructures such as roads and bridges managed by a nation or a local government.

### 2. Description of the Related Art

It is said that the number of infrastructure facilities such as roads, bridges, and tunnels managed by the nation and local government, maintenance of which has been performed more than 50 years ago, will reach its majority in 2030, and periodic inspection and repair are essential.

As a technology regarding such infrastructure maintenance management, for example, JP 2015-7341 A (Patent Literature 1) discloses a mechanism for allocating a road surface repair cost by providing a cost table that stores a repair cost for each road surface state detected at the time of travel by a vehicle, a calculation unit that allocates a repair cost to a road surface having a road surface state exceeding a reference state and calculates a total of the repair cost of the road surface in a predetermined section, and a simulation unit that changes the reference state and calculates the total of the repair cost on the basis of the changed reference state.

For example, Japanese Patent Application Laid-Open No. 2022-646 (Patent Literature 2) discloses a mechanism including a composite image generation unit that generates a composite image indicating a surface of a structure such as a bridge or a tunnel on the basis of a plurality of images and position information, a crack detection unit that analyzes the composite image or an image before composition to detect a crack on the surface of the structure, and a crack information generation unit that generates crack information indicating a crack image corresponding to the detected crack and a feature amount of the crack, in which an image of a cracked site is analyzed to present the composite image and an image analysis result to a user.

### SUMMARY OF THE INVENTION

According to the conventional technology mentioned above, it is possible to implement a mechanism in which a user can easily confirm an inspection result of an infrastructure by an image and the user can easily adjust a cost so that the cost falls within a budget in repair works at a plurality of sites.

In contrast, there is a demand for a mechanism that supports implementation of maintenance management by condition based maintenance (CBM) in which infrastructures in a wide range are repeatedly inspected in a shorter cycle and repair works and preventive works are performed as needed when a site requiring repair is detected under a situation in which aged infrastructures increase instead of conventional inspection and repair of infrastructures commonly operated in a form of periodic inspection and repair for major infrastructures in a cycle of several years such as five years.

Therefore, an object of the present invention is to provide an infrastructure maintenance management support system that senses a state of an infrastructure such as a road and a bridge at high frequency, in wide range, and at low cost to monitor the latest state, and to support implementation of preventive maintenance type maintenance management by CBM on the basis of accumulated data.

The above-described and other objects and novel features of the present invention will be clarified by the description in this specification and the attached drawings.

Overview of a representative one of the inventions disclosed in the present application will be briefly described as follows.

An infrastructure maintenance management support system as a representative embodiment of the present invention is an infrastructure maintenance management support system that supports infrastructure maintenance management, the system including a data management unit that acquires and holds data including map data, sensing data acquired by sensing a state of an infrastructure, and repair actual result data of the infrastructure, a map display unit that displays information regarding the state of the infrastructure determined on the basis of the sensing data in a superimposed manner on a map image based on the map data, a repair support unit that predicts a future degree of deterioration of each infrastructure on the basis of data including the sensing data and presents a candidate for an infrastructure to be repaired on the basis of information including the prediction, and an operation/management unit that displays a result of aggregation of the sensing data and data related to the infrastructure maintenance management on a dashboard in addition to the map image.

The advantageous effect of the representative one of the inventions disclosed in the present application will be briefly described as follows.

That is, according to the representative embodiment of the present invention, it is possible to sense the state of the infrastructure at high frequency, in wide range, and at low cost to monitor the latest state, and to implement preventive maintenance type maintenance management by CBM on the basis of accumulated data.

### BRIEF DESCRIPTION OF THE DRAWINGS

FIG. 1 is a diagram illustrating an overview of a configuration example of an infrastructure maintenance management support system as one embodiment of the present invention;

FIG. 2 is a diagram illustrating an overview of an example of an operation of infrastructure maintenance management in one embodiment of the present invention;

FIG. 3 is a diagram illustrating an overview of an example of LCM in one embodiment of the present invention;

FIG. 4 is a diagram illustrating an overview of an example of a flow of processing of the LCM in one embodiment of the present invention;

FIG. 5 is a view illustrating an overview of an example of screen display in one embodiment of the present invention;

FIG. 6 is a view illustrating an overview of another example of screen display in one embodiment of the present invention;

FIG. 7 is a diagram illustrating an overview of a configuration example of road surface property data in one embodiment of the present invention;

FIG. 8 is a diagram illustrating an overview of a configuration example of sensing data under road surface in one embodiment of the present invention; and

FIG. 9 is a diagram illustrating an overview of a configuration example of tunnel inspection data in one embodiment of the present invention.

### DETAILED DESCRIPTION

An embodiment of the present invention will be described in detail below with reference to the drawings. Note that, in all the drawings for describing the embodiment, the same part is denoted by the same reference sign in principle, and description thereof will not be repeated. In contrast, in some cases, a part described with a reference sign in a certain drawing might be referred to with the same reference sign in the description of another drawing although not illustrated again.

<Overview>

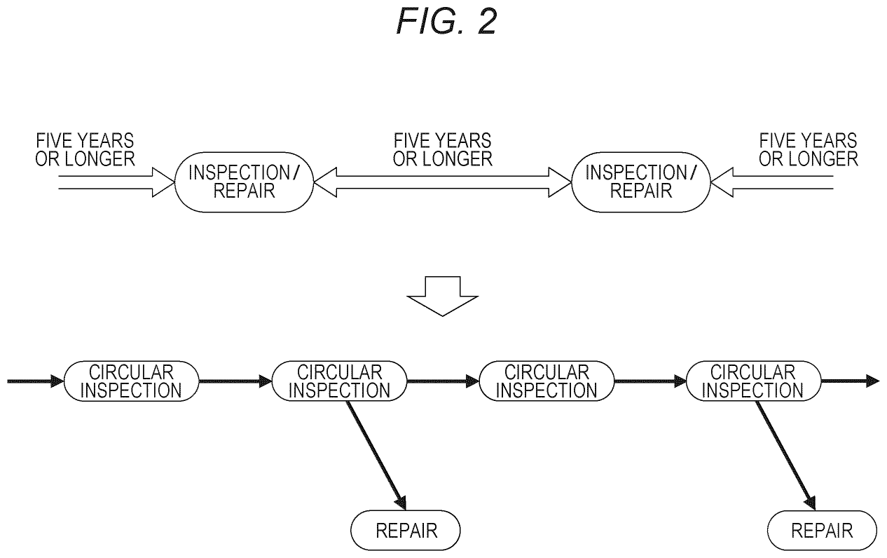

FIG. 2 is a diagram illustrating an overview of an example of an operation of infrastructure maintenance management in one embodiment of the present invention. An upper part of the drawing illustrates a conventional example of an operation of infrastructure maintenance management, and a lower part illustrates the example of the operation targeted in the present embodiment. As described above, it has been conventionally common to operate in a form in which inspection and repair of main infrastructures are periodically performed as one set in a long cycle of five years or longer as illustrated in the upper part of the drawing. On the other hand, in the present embodiment, CBM is implemented by repeatedly inspecting a wide range of infrastructures at low cost with a shorter cycle (circulation inspection), and performing repair work as needed when a site requiring repair (including preventive repair) is detected as illustrated in the lower part of the drawing.

Note that, in addition to inspecting all the infrastructure facilities to be managed in a long cycle of five years or longer, a partial inspection has been performed in a long cycle, and a current state has been predicted on the basis of a uniform mathematical expression using very old inspection data for the remainder; however, there has been a problem of a deviation from an actual state. Future prediction is performed using a mathematical expression or AI also in the present embodiment, but this problem can be solved by adopting inspection in a short cycle to such an extent that deviation does not arise a problem or entire inspection.

FIG. 3 is a diagram illustrating an overview of an example of life cycle management (LCM) in one embodiment of the present invention. In the present embodiment, first, a state of an infrastructure is inspected and sensed to acquire and accumulate sensing data (lower right part of the drawing). Then, the state of the infrastructure is visualized for a user by mapping the state on a map on the basis of the accumulated sensing data, performing 3D modeling of the infrastructure and the like (lower left part of the drawing).

Then, a site of which repair is considered to be necessary (or recommended) is extracted to be presented, an infrastructure to be repaired is determined, and creation of a repair plan is supported (upper left part of the drawing). Then, as execution of the repair based on the repair plan, procurement of a repair company, progress of work, management of a budget and the like are supported (upper right part of the drawing). Then, the LCM from the inspection to the maintenance management of the infrastructure is digitized by performing inspection and sensing again on the repaired infrastructure together with data of repair actual result to acquire data of the infrastructure state (lower right part of the drawing).

An infrastructure maintenance management support system according to one embodiment of the present invention is an information processing system that supports infrastructure maintenance management as described above, and includes “monitoring” to inspect (sense) the state of the infrastructure at high frequency and “digital twin” to visualize the state of the infrastructure on the basis of the accumulated sensing data and accurately and easily analyze the same, thereby supporting preventive maintenance type optimal repair by the CBM. That is, this monitors the latest state by sensing the infrastructure state at high frequency, in wide range, and at low cost, manages the collected sensing data and various types of infrastructure maintenance management related information in a centralized manner, and utilizes the data accumulated by the sensing at high frequency, thereby implementing the CBM.

For example, in a case where a target infrastructure is a road, in the “monitoring” service, inspection and sensing are performed at high frequency, in wide range, and at low cost by attaching a sensor to a patrol car, a drone and the like, and a state under a road surface is simultaneously sensed in addition to the road surface, so that it becomes possible to implement transition from conventional inspection and repair of only a main road once in several years to automatic sensing at high frequency, in wide range, and with homogeneous accuracy. In the “digital twin” service, data such as a sensing result and a repair actual result is managed in a centralized manner, a road condition is mapped on a map to be visualized, and advanced and efficient repair plan and work are supported by analysis of the accumulated sensing data, so that it is possible to implement transition from conventional follow-up maintenance type repair with no future prediction to preventive maintenance type repair based on future deterioration prediction.

<System Configuration>

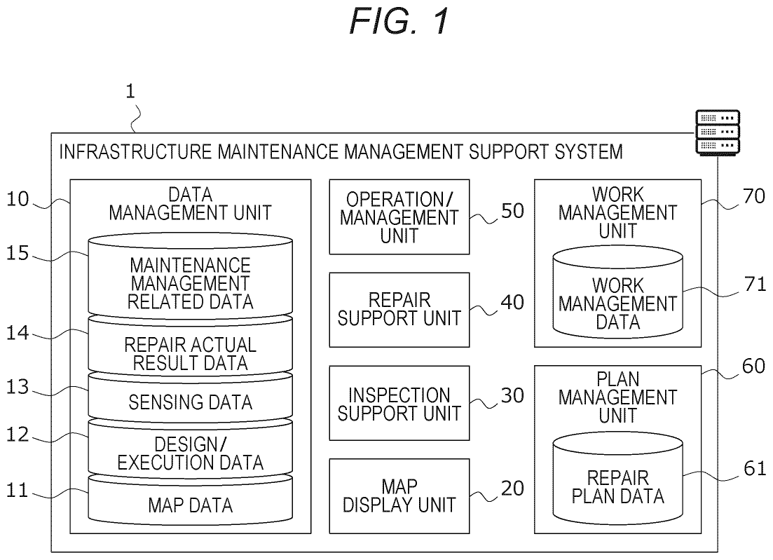

FIG. 1 is a diagram illustrating an overview of a configuration example of an infrastructure maintenance management support system as one embodiment of the present invention. An infrastructure maintenance management support system 1 includes, for example, a virtual server built on a server device and a cloud computing service, a PC and the like, and implements various functions regarding infrastructure maintenance management by executing middleware such as an operating system (OS), a database management system (DBMS), and a web server program expanded on a memory from a recording device such as a hard disk drive (HDD) and a solid state drive (SSD) by a central processing unit (CPU) not illustrated, and software operating thereon.

Note that, an entire infrastructure maintenance management support system 1 or a part thereof may be utilized, used, operated, and maintained by a system company, or by a nation, a local government, a company engaged in infrastructure maintenance management and the like, for example (construction company, work company, inspection company, system integrator, security company or the like).

The infrastructure maintenance management support system 1 includes, for example, units such as a data management unit 10, a map display unit 20, an inspection support unit 30, a repair support unit 40, an operation/management unit 50, a plan management unit 60, and a work management unit 70 implemented as software. This also includes each data store of map data 11, design/execution data 12, sensing data 13, repair actual result data 14, maintenance management related data 15, repair plan data 61, work management data 71 and the like implemented as a database, a file and the like.

Note that, in the example in FIG. 1, the respective components (or a part thereof) are represented to be implemented on one server system, but this is a logical representation, and in practice, a part of or all of the components may be implemented as individual servers, computers, systems, services and the like, and may be configured to cooperate via a network not illustrated. A computer on which a part of each component or a part of any component is implemented may be configured to be usable by any one of the country, local government, company engaged in infrastructure maintenance management and the like described above.

For example, the inspection company imports data acquired by inspecting the infrastructure into the infrastructure maintenance management support system 1, and the system integrator visualizes an infrastructure state on the present system using the imported data of inspection. Then, the construction company makes a repair plan using the present system, places an order using the present system according to the repair plan, and the work company manages the progress of the ordered work on the present system.

In the above-described example also, the infrastructure maintenance management support system 1 of the present embodiment can be used in each of a case where each company engaged in the infrastructure maintenance management and the like individually concludes a contract with the nation, local government and the like as an orderer (hereinafter, sometimes referred to as an “individual entrusted model”) and a case where a plurality of companies engaged in the infrastructure maintenance management and the like or an aggregate thereof comprehensively concludes a contract with the nation, local government and the like as an orderer for a plurality of infrastructures (hereinafter, sometimes referred to as a “comprehensive entrusted model” (sometimes also referred to as a “comprehensive management model” or a “comprehensive private entrusted model)). Then, the orderer can use and operate the entire infrastructure maintenance management support system 1 or a part thereof, and browse information and the like.

Examples of the individual entrusted model include, for example, a case in which the orderer browses and confirms the state of the target infrastructure visualized in the infrastructure maintenance management support system 1 by the system integrator, the orderer browses and approves the repair plan formulated by the construction company using the present system, the orderer orders (or supports ordering) each work of an entire repair plan or a part thereof using the present system and the work company receives the order, and the orderer confirms a work progress status input by the work company to the present system.

In contrast, examples of the comprehensive entrusted model include, for example, a case in which the above-described aggregate browses and confirms the state of the target infrastructure visualized in the infrastructure maintenance management support system 1 by the system integrator, the above-described aggregate browses and approves the repair plan formulated by the construction company using the present system, the above-described aggregate orders (or supports ordering) each work of the entire repair plan or a part thereof using the present system and the work company receives the order, and the above-described aggregate confirms the work progress status input by the work company to the present system.

As a principal role of the orderer side in the above-described example of the comprehensive entrusted model, there is periodic monitoring of comprehensive entrusted business; it is also possible to perform this monitoring using the present system, to supervise whether execution of an entrusted content is according to a standard determined in advance or above the standard, and to issue a correction instruction using the present system if the execution is below the standard. A model may be a model to which availability payment (AP) (one of payment methods used in a performance-based contract in which the performance of the target infrastructure is specified (for example, performance such as maintaining an average crack rate of a target road to be equal to or smaller than a predetermined value is specified), maintenance management is entrusted, and payment is made when the performance is observed) used in combination with the comprehensive entrusted model is applied.

In other words, it can be said that this model is a model in which maintenance management satisfying the above-described performance specification is performed, and in a case where the maintenance is not performed, a payment amount is reduced. The infrastructure maintenance management support system 1 of the present embodiment can be used in such a model. Furthermore, in the above description, it has been described that execution supervision of the entrusted content is performed in the present system; however, in the present system, it may be configured that it is determined to pay a predetermined amount of money if the performance specification or more is satisfied, and it is determined to pay the amount of money obtained by subtracting an adequate amount of money from the predetermined amount of money if less than the performance specification is satisfied. Furthermore, this may have a function of approval of an amount of payment and execution of payment (request for payment to a financial institution).

Returning to FIG. 1, the data management unit 10 has a function of appropriately acquiring and accumulating, and managing various data including the data acquired by the inspection and sensing of the infrastructure. When acquiring the data, for example, it may be configured that required data is automatically or semi-automatically acquired in connection with or in cooperation with an external system or service such as the nation, local government, company, or association, or it may be configured that an operator or the like inputs or uploads data, and these configurations may be selectively used depending on a type of the data. In a case where the data is externally acquired, processing such as changing a format may be performed as appropriate.

For example, the map data 11 holds (two-dimensional/three-dimensional) map data as a base for screen display. The design/execution data 12 holds design information and execution information when the nation or local government develops each infrastructure. The sensing data 13 holds data (for example, in a case of a road, data regarding a road surface property, a structure under the road surface, a cavity and the like) acquired by inspecting and sensing the infrastructure by various units. The repair actual result data 14 holds data regarding an actual result such as a past repair period, a method, and a repair material for each infrastructure. The maintenance management related data 15 holds other related information (for example, in a case of the road, data of resident report (complaint), traffic volume data, weather and the like) at the time of infrastructure maintenance management. Note that, such configuration of the data store is merely an example, and it goes without saying that another configuration may be adopted or a configuration in which data other than the above is acquired and held may be adopted.

Note that, it may be configured that the sensing data 13 has a data attribute of a data source, and determined whether to be processed by the map display unit 20, the inspection support unit 30, and the repair support unit 40 to be described later depending on a value of the data source. For example, if processing of map display, inspection support, and repair support is performed using only the sensing data completely conforming to the present system (hereinafter, sometimes referred to as “sensing data for the present system”) acquired by direct inspection by a company that operates the infrastructure maintenance management support system 1 and the like, the data content can be assumed in advance, so that compatibility with the present system is high.

In contrast, since it is not realistic to accumulate a required amount of sensing data in a short period of time, for example, there is a case where it is necessary to use sensing data acquired by an infrastructure facility management company by requesting an inspection from an external company in the past, or sensing data obtained by converting the sensing data into data in conformity with the sensing data of the present system (hereinafter, sometimes referred to as “external sensing data).

Therefore, for example, it may be configured that, when the infrastructure maintenance management support system 1 of the present embodiment is started to be used, the sensing data including the external sensing data in addition to the sensing data for the present system is made the processing target for the map display, the inspection support, and the repair support, and after the sensing data for the present system is sufficiently accumulated, only the sensing data for the present system is made the processing target for the map display, the inspection support, and the repair support. As described above, since the sensing data 13 has the data attribute of the data source, it can be implemented by setting only the sensing data having a desired data attribute as a processing target.

Note that, in a case where data of the sensing data 13 is learned by AI as teacher data, in a case where learning is performed including the external sensing data in addition to the sensing data for the present system, a case where relearning with only the sensing data for the present system is required might occur. However, in a case where an amount of the sensing data for the present system is larger than an amount of the external sensing data, an influence of the external sensing data on weighting of the learning model is slight, so that the relearning is not necessarily required in some cases.

Returning to FIG. 1, the map display unit 20 has a function of mapping, displaying, and visualizing various pieces of maintenance related information on the same map. Screen display can be performed, for example, on a display of an information processing terminal of the user connected to the infrastructure maintenance management support system 1 via a network not illustrated. A dedicated application program not illustrated may be operated to display, or a web browser may be used to display. For example, states of respective roads determined on the basis of the data of the sensing data 13 are color-coded and mapped to be displayed on a map image based on the data of the map data 11, and information of the resident report, traffic volume, weather and the like regarding the target road is appropriately superimposed to be displayed on the basis of the data of the maintenance management related data 15, so that it becomes easy to visualize a wide variety of maintenance related information on the same map and share the information with other organizations, persons in charge and the like.

The inspection support unit 30 has a function of efficiently supporting the inspection and sensing of the infrastructure. For example, on the basis of past data of the sensing data 13, the data of the repair actual result data 14 and the like, it is possible to set the cycle and frequency of the inspection and patrol for each infrastructure, or extract and suggest an infrastructure or a site thereof for which the inspection and patrol are required or recommended in a preventive manner. This may have a function of selecting and suggesting an optimal route for the inspection or patrol. As the cycle and frequency of the inspection, for example, several times a year, several times a month, several times a week and the like can be set, and an appropriate cycle can be appropriately set according to a characteristic of the individual infrastructure (for example, in a case of the road, difference in traffic volume, deterioration speed of the road surface and the like among roads).

Note that, it may be configured that, for a target site in the target infrastructure, a result of the deterioration prediction at a certain point of time in future performed by the repair support unit 40 to be described later in the past may be compared with an inspection value acquired by the inspection actually performed at that point of time, and an inspection cycle is determined on the basis of a difference between a deterioration prediction value and the inspection value. For example, in September 2021, the deterioration prediction for a section A of the road at a point of time on September 2022 in the future after one year is performed. Thereafter, a result of the inspection actually performed in September 2022 is compared with the deterioration prediction value acquired in September 2021, and if a difference therebetween is equal to or smaller than a predetermined threshold, the inspection cycle may be set to a normal inspection cycle, and on the other hand, if the difference is larger than the predetermined threshold, the inspection cycle shorter than the normal inspection cycle may be presented.

Regarding the site and section of the infrastructure where the inspection or patrol is to be performed, for example, a section where the inspection has been already performed is grasped from the record of the sensing data 13 and the like, and then a section to be inspected next is specified and suggested as an inspection plan together with an optimal route. In a case where the actual result of the section where the inspection is actually performed on the inspection day falls below the plan, the section where the inspection is not performed yet may be added as a target for the next inspection. On the other hand, in a case where the section exceeding the plan is actually inspected, the section scheduled for the next inspection may be handled as the section inspected in advance, and the inspection section after the next inspection may be inspected in advance in the next inspection.

A function of automatically or semi-automatically determining soundness of the inspection result of the target infrastructure on the basis of the data recorded in the sensing data 13 as the result of the inspection may be provided. Note that, in implementing each of these functions, for example, AI or a known technology can be appropriately used, for example.

Returning to FIG. 1, the repair support unit 40 has a function of supporting advancement of repair in order to implement the preventive maintenance type infrastructure repair. For example, this may have a function of predicting deterioration of each infrastructure on the basis of the data of the design/execution data 12, sensing data 13, repair actual result data 14, maintenance management related data 15 and the like, extracting the infrastructure or the site thereof for which the repair is required or recommended in a preventive manner, and recommending an optimal method for the repair. As for the infrastructure that needs to be repaired, for example, priority may be provided in consideration of the information such as the traffic volume and weather of each road. Furthermore, this may also have a function of simulating a life cycle cost (LCC) of the infrastructure when the repair is performed according to the suggestion, and may formulate a repair plan draft in consideration of a cost. For example, the formulated repair plan draft may be registered in the repair plan data 61 to be used for formulating a detailed repair plan.

The operation/management unit 50 has a user interface and other functions for the user to operate and manage the infrastructure maintenance. For example, this has a function of graphically visualizing the state of the infrastructure and various types of maintenance related information as a so-called dashboard on the same screen as the map displayed by the map display unit 20. This also has a function of holding and managing various types of master data required or referred to for the operation and management of infrastructure maintenance, various conditions and setting information regarding the determination of whether the repair is required and, if so, how much repair is to be performed and the like.

Each unit described above can perform the inspection and sensing on the infrastructure at high frequency, automatically or semi-automatically diagnose a result, suggest necessity of repair or a repair content, and implement data-driven repair work (CBM) and advancement of operation management.

The plan management unit 60 has a function of supporting formulation of a detailed repair plan for the infrastructure to be repaired. For example, in addition to the information on the repair site, method, and cost specified by the repair support unit 40 and registered in the repair plan data 61, an input of a work schedule, information regarding procurement of a work company, information regarding a detailed budget plan and the like may be received and registered in the repair plan data 61. It is also possible to configure that these contents are automatically set on the basis of conditions, setting information and the like set in the operation/management unit 50.

The work management unit 70 has various functions regarding project management such as progress management of repair work performed on the basis of the repair plan data 61 and the like, various procurement and ordering operations, and budget management. A generally available project management tool and the like may be used. The information regarding the project management can be recorded in the work management data 71, for example. The actual result data when the repair is completed may be recorded in the repair actual result data 14.

For example, various orders are placed online on the basis of the content of the repair plan data 61, and confirmation of the progress and status of work, budget confirmation, check when the work is completed, and planning and suggestion of subsequent periodic inspection and patrol are performed. Confirmation or sensing for check may be performed on the section subjected to work, and in a case where the soundness is sufficiently recovered, it may be determined that the check is completed and work is completed. Note that, even in a case where the soundness is recovered, in a case where minimum soundness to be maintained for at least a predetermined period cannot be maintained in the subsequent periodic inspection or deterioration prediction, the target section may be included in a target to be inspected in the next inspection or a target recommended to be repaired.

<Flow of Processing>

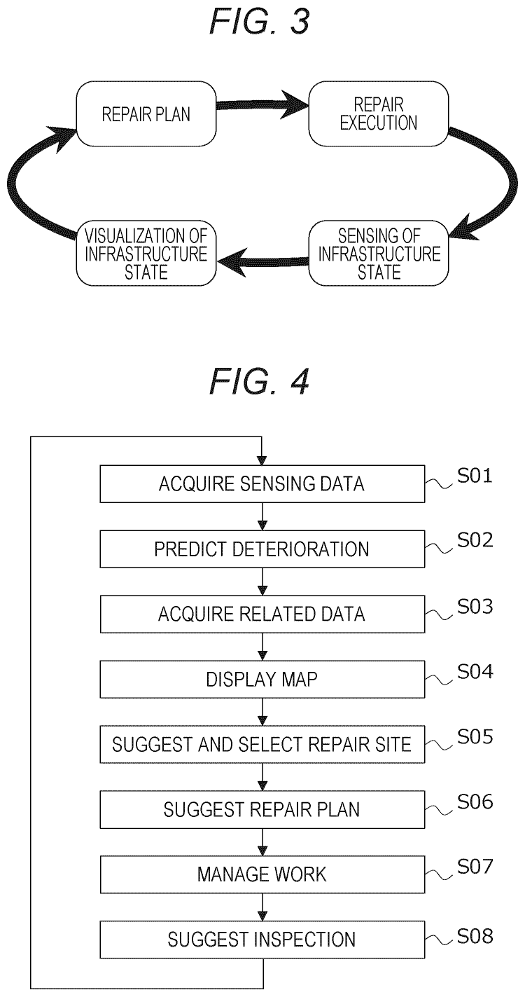

FIG. 4 is a diagram illustrating an overview of an example of a flow of processing of the LCM in one embodiment of the present invention. First, in an initial state in which the sensing data is not accumulated, an inspection plan is formulated outside the system to perform the inspection, and the sensing data regarding the state of the infrastructure is acquired (S01). For example, in a case of the road, the sensing data is acquired while traveling on a target road by a patrol car equipped with various sensors. In a case of a bridge or a tunnel, the sensing data may be acquired by allowing a drone equipped with a camera or a sensor to fly. Information may be acquired from a sensor directly installed in an infrastructure facility such as a bridge via the Internet or the like. The inspection support unit 30 may suggest an optimal inspection and patrol route.

Note that, the road, tunnel, and bridge are examples of the infrastructure, and a sensing target may be a state of planting or cleaning, a park, a state of snow removal, a street light, a reflecting mirror, a road sign and the like. As a sensing method, a known conventional technology can be appropriately used, and for example, regarding the planting, it is possible to determine whether this is in a normal state by comparing a photograph immediately after maintenance with a photograph thereafter, or by performing image determination on whether a branch of a tree extends to a road or an electric wire.

In addition to a configuration of acquiring the sensing data using the sensing device by the patrol car, for example, a configuration in which a patrol person can input various items (for example, additional report items of the road surface properties, road depression, leaving of large-sized trash and the like) as patrol contents after adding position information to the infrastructure maintenance management support system 1 may be adopted. As a result, a manager who confirms, supervises, and monitors the state of the infrastructure using the present system can confirm the above-described items input by the patrol person. On the other hand, it is also possible that the patrol person executes patrol or a measure in accordance with the content input by the manager and inputs the result to the present system.

The acquired sensing data is recorded to be accumulated in the sensing data 13 by the data management unit 10. The inspection support unit 30 may automatically determine the soundness by AI on the basis of the sensing data 13.

Thereafter, the repair support unit 40 predicts deterioration of the target infrastructure on the basis of the accumulated data of the sensing data 13, the design/execution data 12 and the like (S02). A method of deterioration prediction is not especially limited, and various known methods can be appropriately adopted. Then, various data regarding the target infrastructure are acquired from the design/execution data 12, the repair actual result data 14, the maintenance management related data 15 and the like (S03), and they are mapped to be displayed on a two-dimensional/three-dimensional map by the map display unit 20 and displayed on a dashboard by the operation/management unit 50 (S04).

The user selects a site to be repaired while confirming the state of the infrastructure visualized on the map display or the dashboard through various viewpoints (S05). At that time, in order to contribute to selection by the user, the repair support unit 40 may suggest a candidate for a site where the repair is required or recommended on the basis of the result of the deterioration prediction at step S02 and the like. When the repair site is selected, the repair support unit 40 creates the repair plan and suggests the same to the user (S06). When creating the repair plan, for example, suggestion of an optimal method for repair is included, and a simulation result of the LCC of the target infrastructure in a case of performing the repair according to the suggestion is also presented.

When the repair plan is selected, the plan management unit 60 registers the repair plan (or a repair plan corrected or adjusted based on the same) in the repair plan data 61, and repair work is performed on the basis of the repair plan. The work management unit 70 may procure the work company or order the materials online. Processing regarding project management such as the progress of repair work and management of budget is performed (S07). The actual result data when the repair is completed is recorded in the repair actual result data 14.

Thereafter, for example, the inspection support unit 30 extracts and suggests the infrastructure to be inspected and sensed and the site thereof on the basis of the cycle of the inspection, the state of the infrastructure and the like set on the basis of the design/execution data 12, sensing data 13, repair actual result data 14, maintenance management related data 15 and the like for each infrastructure (S08), and returns to step S01 to repeat a series of cycle of actually performing the inspection and sensing on the infrastructure to be inspected and acquiring the data.

### Screen Example

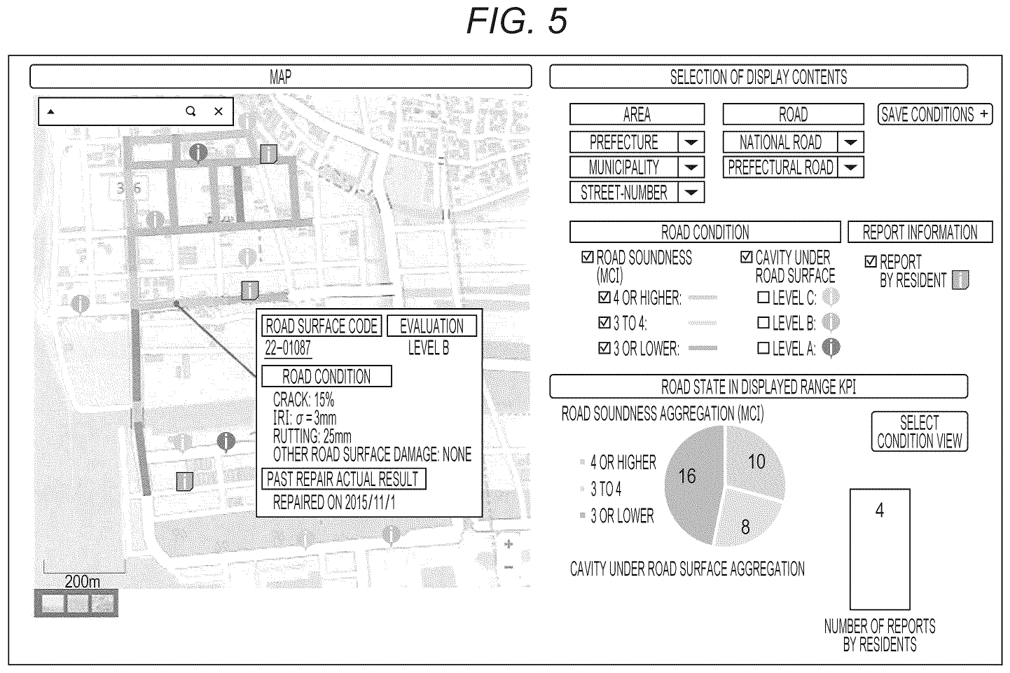

FIG. 5 is a view illustrating an overview of an example of screen display in one embodiment of the present invention. FIG. 5 illustrates an example of visualization by digital twin in a case where the road is targeted as the infrastructure. Specifically, a road map of an area and the like specified by a filter on a right side of the screen is displayed on a left side of the screen, and information such as road soundness (maintenance control index: MCI) specified by the filter, road conditions such as a cavity under a road surface, resident reports and the like is mapped on the road by color coding or a mark of the road to be displayed. An aggregation result of these indexes is displayed as a dashboard in a lower right part of the screen. With such screen display, it is possible to reduce a load of information collection when the user examines the repair plan, and to implement efficiency of the examination.

For example, by superimposing and displaying data of a plurality of types of inspection results (for example, a bridge, a road surface on the bridge and the like) on the map, it is also possible to estimate a mutual causal relationship between sites having a worse degree of damage. For example, by displaying data other than the sensing data such as the number of resident reports such as “the road at a place ∘∘ is damaged”, it is possible to compare the latest inspection result (the soundness of the infrastructure and the content of the deterioration prediction) with the report content and the result of the subsequent inspection and to support more accurate and efficient determination on the degree of damage and the like.

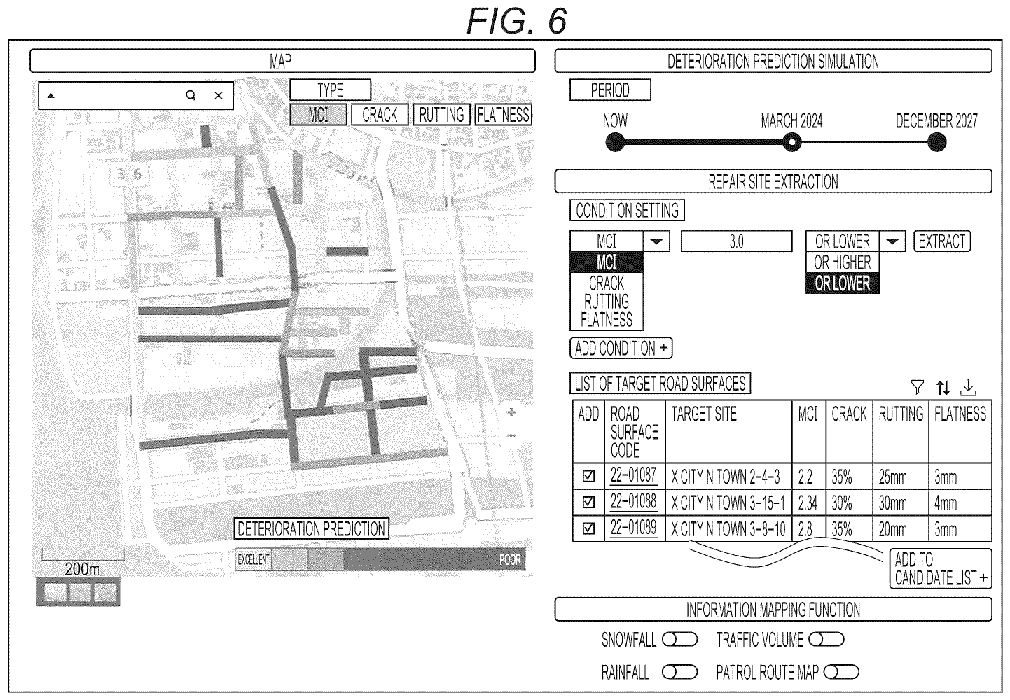

FIG. 6 is a view illustrating an overview of another example of screen display in one embodiment of the present invention. As described above, in the present embodiment, not only the results of inspection and sensing are displayed on the screen as in the example in FIG. 5, but also a simulation of the deterioration prediction of the infrastructure is performed on the basis of the accumulated sensing data 13 and the like, and a site exceeding a repair reference value set in advance (or a site in which AI determines that the repair is required) is automatically extracted, and mapped on the map to be displayed as a candidate for a repair site on future date as illustrated in the example in FIG. 6. In this manner, by freely combining and displaying the result of the deterioration prediction, the map display, and the related information such as the weather and traffic volume, it is possible to optimally support the selection of the candidate for the repair site.

<Sensing Data>

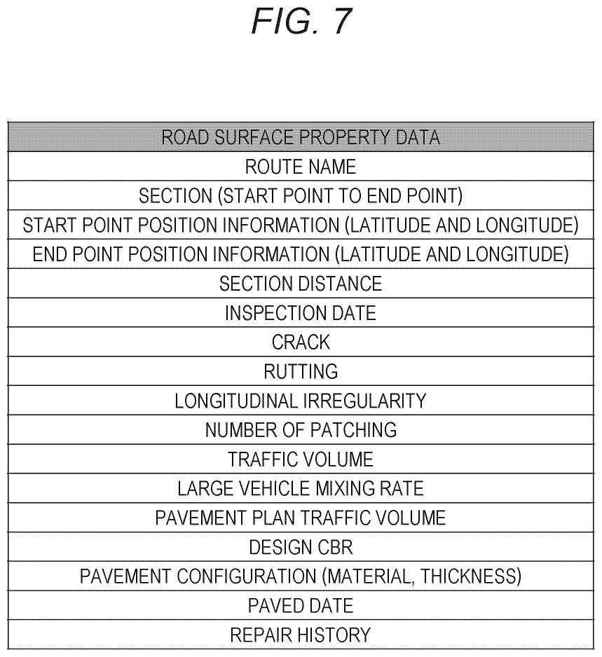

Specific examples of various types of sensing data accumulated in the sensing data 13 (also including design/execution data 12, repair actual result data 14, and information of the infrastructure acquired with reference to master information and the like managed by the operation/management unit 50) will be described below. FIG. 7 is a diagram illustrating an overview of a configuration example of road surface property data in one embodiment of the present invention. An item of “route name” holds information such as a name and a number specifying a target route, for example, “National Route ∘”. Each item of “section (start point to end point)”, “start point position information (latitude/longitude)”, and “end point position information (latitude/longitude)” holds information in which the start point and the end point of the section obtained by dividing the target route into sections are specified by a distance (∘m to □m) from the start point of the target route and the latitude/longitude. An item of “section distance” holds information of a distance (m) of the target section.

An item of “inspection date” holds information of the year and month when the latest inspection has been performed on the target section. Each item of “crack”, “rutting”, “longitudinal irregularity”, and “number of patching” holds information of a rate (%) at which cracks exist in the target section, a depth of rutting (mm), a value of international roughness index (IRI) for evaluating longitudinal irregularity (mm/m), and the number of patching, respectively.

Each item of “traffic volume”, “large vehicle mixing rate”, and “pavement planning traffic volume” holds information of the traffic volume per day (vehicles/day) of the target section, the proportion (%) of large vehicles among them, and the pavement planning traffic volume (the traffic volume per day per lane of large vehicles defined as the basis of the design of the pavement). An item of “design CBR” holds information of a design California bearing ratio (CBR) of the target section. An item of “pavement configuration (material, thickness)” holds information of a used material and a thickness (cm) thereof for each of a surface layer, a base layer, and a roadbed of the road. An item of “pavement date” holds information of the data when the road of the target section is paved, and an item of “repair history” holds the repair date and history information of a repair content of the target section.

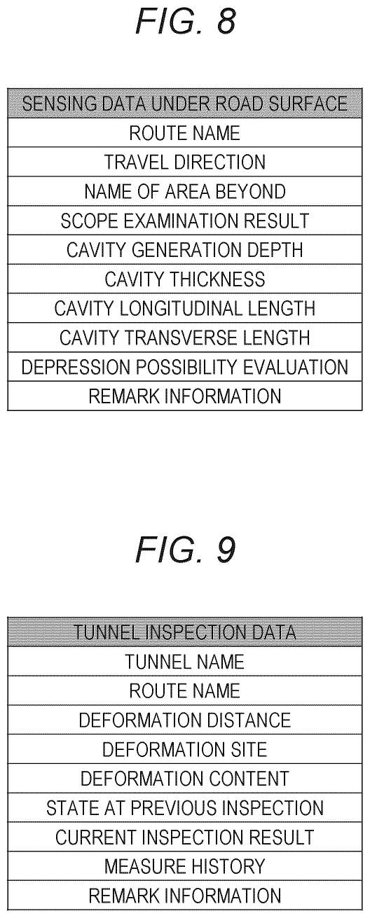

FIG. 8 is a diagram illustrating an overview of a configuration example of sensing data under road surface in one embodiment of the present invention. An item of “route name” holds information such as a name and a number specifying a target route as in the example in FIG. 7 described above. An item of “travel direction” holds information of a travel direction (for example, eastbound, westbound, northbound, southbound and the like) of the target route. “Name of area beyond” holds information of a name of area beyond the site where the sensing data is acquired (for example, 1-1, Δ Ward, ∘ City and the like).

An item of “scope examination execution result” holds information of whether an examination by inserting a scope into a place estimated to be a cavity under the road surface has been performed, and a result (whether or not this is a cavity) of the examination in a case where the examination has been performed. Each item of “cavity generation depth”, “cavity thickness”, “cavity longitudinal length”, and “cavity transverse length” holds information of a generation depth, thickness, and vertical and horizontal sizes (m) indicating the scale of the cavity. An item of “depression possibility evaluation” holds a result of evaluation of the depression possibility by the inspection support unit 30 or the like by, for example, 5-stage evaluation. For example, evaluation may be performed by comparison with a predetermined reference value, or determination may be made by AI. An item of “remark information” holds remark information regarding the target sensing data (information of the cavity). For example, information such as the target cavity is “near ∘m in the vicinity of the sewer pipe” is recorded.

FIG. 9 is a diagram illustrating an overview of a configuration example of tunnel inspection data in one embodiment of the present invention. Each item of “tunnel name” and “route name” holds information such as a name and a number specifying the target tunnel and the route to which the target tunnel belongs. An item of “deformation distance” holds information of a distance (m) from a tunnel start point of a site where deformation is detected. An item of “deformation site” holds information of the portion in the tunnel of the target deformation (for example, “covering of a left arch” and the like). An item of “deformation content” holds information of classification and type of deformation (for example, “crack due to external force”, “water leakage from water guiding”, “material deterioration of joint portion” and the like).

An item of “state at previous inspection” holds information indicating a state and soundness at the time of previous inspection of the target site. An item of “current inspection result” holds information such as classification of current inspection and sensing (for example, whether it is before or after emergency measures and the like), and necessity of examination and measure. For example, it may be automatically set to perform the examination or measure in a case where magnitude of the deformation is larger than a predetermined value, or it may be determined whether or not the examination or measure is necessary by AI. An item of “measure history” holds, in a case where it is determined that the examination or measure is necessary for the target site, information on a status of execution (for example, already executed, continuously executed and the like) and the content thereof (for example, “monitoring (intensive or daily patrol)”, “execution of work to prevent peeling off” and the like). An item of “remark information” records, for example, information such as a response policy to deformation of the target site and special remarks”.

As described above, the infrastructure maintenance management support system 1 according to one embodiment of the present invention includes “monitoring” by inspecting (sensing) the state of the infrastructure at high frequency and “digital twin” to visualize the state of the infrastructure on the basis of the accumulated sensing data and accurately and easily analyze the same, so that this may support preventive maintenance type optimal repair by the CBM. That is, this can monitor the latest state by sensing the infrastructure state at high frequency, in wide range, and at low cost, manage the collected sensing data and various types of infrastructure maintenance management related information in a centralized manner, and utilize the data accumulated by the sensing at high frequency, thereby implementing the CBM.

Although the invention made by the present inventors has been specifically described above on the basis of the embodiment, the present invention is not limited to the above embodiment, and it goes without saying that various modifications can be made without departing from the gist of the present invention. The above embodiment has been described in detail in order to explain the present invention in an easy-to-understand manner, and the present invention is not necessarily limited to one including all the configurations described. Another configuration can be added to, deleted from, and replaced with a part of the configuration of the above-described embodiment.

Part or all of the above-described configurations, functions, processing units, processing units and the like may be implemented by hardware by being designed as an integrated circuit or the like, for example. Alternatively, the above configurations, functions and the like, may be implemented by software by a processor interpreting and executing a program that implements each function. Information such as programs, tables, and files for implementing each function can be stored in a recording device such as a memory, a hard disk, a recording device such as a solid state drive (SSD), or in a recording medium such as an IC card, an SD card, and a DVD.

The above drawings illustrate control lines and information lines that are considered necessary for the description and do not necessarily illustrate all the implemented control lines and information lines. It may be considered that almost all the configurations are mutually connected in practice.

The present invention can be used for an infrastructure maintenance management support system for infrastructures such as roads and bridges managed by the nation or local government.

What is claimed is:

1. An infrastructure maintenance management support system that supports infrastructure maintenance management, the system comprising:
a data management unit that acquires and holds data including map data, sensing data acquired by sensing a state of an infrastructure, and repair actual result data of the infrastructure;
a map display unit that displays information regarding the state of the infrastructure determined on the basis of the sensing data in a superimposed manner on a map image based on the map data;
a repair support unit that predicts a future degree of deterioration of each infrastructure on the basis of data including the sensing data and presents a candidate for an infrastructure to be repaired on the basis of information including the prediction; and
an operation/management unit that displays a result of aggregation of the sensing data and data related to the infrastructure maintenance management on a dashboard in addition to the map image.

2. The infrastructure maintenance management support system according to claim 1, further comprising:
an inspection support unit that sets an inspection cycle for each infrastructure and suggests an inspection route for one or more infrastructures to be inspected on the basis of the cycle.

3. The infrastructure maintenance management support system according to claim 2, wherein
the inspection support unit determines soundness of the infrastructure on the basis of the sensing data acquired by the inspection.

4. The infrastructure maintenance management support system according to claim 1, wherein
the repair support unit selects and presents a method to be adopted for repairing the candidate infrastructure by AI.

5. The infrastructure maintenance management support system according to claim 1, wherein
the repair support unit performs simulation of a life cycle cost when repairing the candidate infrastructure, and presents a result.

6. The infrastructure maintenance management support system according to claim 1, further comprising:
a plan management unit that creates a repair plan including a method, a work schedule, and a budget for an infrastructure selected from the candidate and records the repair plan as repair plan data; and
a work management unit that performs project management related to repair work performed on the basis of the repair plan.
